(19) United States
(12) Patent Application Publication
(10) Pub. No.: US 2011/0272856 A1
(43) Pub. Date: Nov. 10, 2011

(54) DRIED BIODEGRADABLE RESIN

(75) Inventors: Robert R. Rasmussen, Lansing, NY (US); Patrick J. Govang, Ithaca, NY (US); Clayton D. Poppe, Ithaca, NY (US); Thomas P. G. Schryver, Ithaca, NY (US); Nathan Ball, Ithaca, NY (US)

(73) Assignee: E2E MATERIALS, Ithaca, NY (US)

(21) Appl. No.: 13/086,533

(22) Filed: Apr. 14, 2011

Related U.S. Application Data
(60) Provisional application No. 61/424,269, filed on Dec. 17, 2010.
(60) Provisional application No. 61/325,072, filed on Apr. 16, 2010.

(51) Int. Cl. B29C 70/02; C08L 5/12

(52) U.S. Cl. 264/297.4; 106/144.1; 106/18.29

(57) ABSTRACT

The present invention provides biodegradable compositions, resins comprising the same, and composites thereof.

### CROSS-REFERENCE TO RELATED APPLICATIONS

The present application claims priority to U.S. provisional application Ser. Nos. 61/325,072, filed Apr. 16, 2010, and 61/242,269, filed Dec. 17, 2010, the entirety of each of which is incorporated herein by reference.

### FIELD OF THE INVENTION

The present invention relates to protein-based polymeric compositions and, more particularly, to biodegradable polymeric compositions containing protein in combination with green strengthening agents.

### BACKGROUND OF THE INVENTION

Concerns about the environment, both with respect to pollution and sustainability, are rapidly rising. Extensive research efforts are being directed to develop environment-friendly and fully sustainable “green” polymers, resins and composites that do not use petroleum and wood as the primary feed stocks but are instead based on sustainable sources such as plants. Such plant-based green materials can also be biodegradable and can thus be easily disposed of or composted at the end of their life without harming the environment. Fibers such as jute, flax, linen, hemp, bamboo, etc., which have been used for many centuries, are not only sustainable but also annually renewable. Because of their moderate mechanical properties, efforts are being directed toward their use in the reinforcement of plastics and the fabrication of composites for various applications. Such fibers may be used alone, as components of yarns, fabrics or non-woven mats, or various combinations thereof. Fully green composites fabricated using plant fibers such as jute, flax, linen, hemp, bamboo, kapok, etc., and resins such as modified starches and proteins have already been demonstrated and commercialized. High strength liquid crystalline (LC) cellulose fibers, prepared by spinning a solution of cellulose in phosphoric acid, can impart sufficiently high strength and stiffness to composites to make them useful for structural applications. However, since natural fibers are generally weak compared to high strength fibers such as graphite, aramid, etc., composites containing them typically have relatively poor mechanical properties, although they may be comparable to or better than wood. Thus, such composites are suitable for applications that do not require high mechanical performance, for example, packaging, product casings, housing and automotive panels, etc. Nonetheless these applications represent large markets, so increasing use of composites containing biodegradable natural materials should contribute substantially towards reducing petroleum-based plastic/polymer consumption.

The use of renewable materials from sustainable sources is increasing in a variety of applications. Biocomposites are materials that can be made in nature or produced synthetically, and include some type of naturally occurring material such as natural fibers in their structure. They may be formed through the combination of natural cellulose fibers with other resources such as biopolymers, resins, or binders based on renewable raw materials. Biocomposites can be used for a range of applications, for example: building materials, structural and automotive parts, absorbents, adhesives, bonding agents and degradable polymers. The increasing use of these materials serves to maintain a balance between ecology and economy. The properties of plant fibers can be modified through physical and chemical technologies to improve performance of the final biocomposite. Plant fibers with suitable properties for making biocomposites include, for example, hemp, kenaf, jute, flax, sisal, banana, pineapple, sugar cane bagasse, corn stover, straw, ramie and kapok.

Biopolymers derived from various natural botanical resources such as protein and starch have been regarded as alternative materials to petroleum plastics because they are abundant, renewable and inexpensive. The widespread domestic cultivation of soybeans has led to a great deal of research into the development of biopolymers derived from their byproducts. Soy protein is an important alternative to petroleum based plastic materials because it is abundant, renewable and inexpensive. Soy proteins, which are complex macromolecular polypeptides containing 20 different amino acids, can be converted into biodegradable plastics. However, soy protein plastics suffer the disadvantages of low strength and high moisture absorption.

As previously disclosed, a biodegradable resin is typically water-based. Water-based resins contain a high percentage of water, which allows the resin to readily permeate and impregnate fabrics and results in even distribution of the resin. However, water-based resins have limitations. Specifically, water-based resins are expensive to transport or ship because of the added weight of the water, which can be as high as 90% by weight. Water-based resins as previously described are not microbiologically stable and are excellent growth mediums for a wide variety of bacteria and fungi. To prevent bacterial or fungal growth, aqueous resins require the further addition of preservatives, or must be frozen to maintain any shelf life. Freezing and thawing an aqueous resin requires significant energy input, further increasing the manufacturing cost. Further, the use of water-based resins requires greater time and energy in both heating the water during the preparation of the resin and removing the water after impregnation. Accordingly, it is beneficial to provide a resin in solid form to increase the shelf-life of the resin, to decrease costs associated with manufacturing and transportation of the resin, and to increase storage capacity.

### DETAILED DESCRIPTION OF THE INVENTION

In certain embodiments, the present invention provides a dry resin comprising a biodegradable polymeric composition. In some embodiments, the biodegradable polymeric composition comprises a protein and a first strengthening agent. A biodegradable composition may optionally include a second strengthening agent. Accordingly, in other embodiments, the biodegradable polymeric composition further comprises a second strengthening agent. In certain aspects, the present invention provides a composite comprising a provided resin. Such biodegradable polymeric compositions, strengthening agents, resins, and composites are described in detail herein, infra

The present invention also provides a method for preparing a dry resin comprising a biodegradable polymeric composition comprising the steps of: preparing an aqueous mixture of a resin comprising a protein and first strengthening agent; and drying the resin to a solid form. In some embodiments, the dry solid form is a powder, in the form of flakes, granules, spheroids, and the like. One of ordinary skill in the art will appreciate that the term “dry” as used herein in connection with a resin or solid form, does not necessarily mean that the resin, or solid form, is anhydrous (i.e., completely devoid of water). Rather, one of ordinary skill in the art will appreciate that a dried resin, or dry solid form, as used herein, can contain an amount of water so as not to interfere with the flowability, stability, and/or processability of the referenced material.

In alternative embodiments, the present invention also provides a method for preparing a dry resin comprising a biodegradable polymeric composition comprising the steps of: preparing a dry resin comprising an admixture of a protein and first strengthening agent. In some embodiments, the dry solid form is a powder, in the form of flakes, granules, spheroids, and the like. One of ordinary skill in the art will appreciate that the term “dry” as used herein in connection with a resin or solid form, does not necessarily mean that the resin, or solid form, is anhydrous (i.e., completely devoid of water). Rather, one of ordinary skill in the art will appreciate that a dried resin, or dry solid form, as used herein, can contain an amount of water so as not to interfere with the flowability, stability, and/or processability of the referenced material.

It will be appreciated that other resin ingredients are similarly incorporated into a dried resin composition of the present invention. For example, in some embodiments, the present invention provides a dried resin comprising a protein and first strengthening agent and optionally further comprising a plasticizer, an anti-moisture agent, or an anti-microbial agent, or combination thereof. Such agents can be added to a provided resin composition as an aqueous mixture (i.e., a suspension or solution) or can be combined with the protein and strengthening agent as an admixture (i.e., a physical mixture of dry ingredients).

The present invention also provides a method for preparing a composite comprising a biodegradable polymeric composition comprising the steps of: applying the dried resin to a fiber mat; optionally wetting the resin/mat complex with suitable wetting agents; and subjecting the complex to conditions of temperature and pressure effective to form a composite comprising the biodegradable polymeric composition.

The present invention further provides a method for preparing a composite comprising a biodegradable polymeric composition comprising the steps of: reconstituting the dry resin in water; coating and/or impregnating a fiber mat with the mixture; heating the impregnated mat to remove water (or otherwise drying the impregnated mat), thereby forming a substantially dry intermediate sheet (also referred to herein as a “prepreg”); and subjecting the intermediate sheet to conditions of temperature and pressure effective to form a composite comprising the biodegradable polymeric composition. Details of these, and other aspects of the invention, are provided herein, infra.

### Definitions

The term “biodegradable” is used herein to mean degradable over time by water and/or enzymes found in nature, without harming the environment.

The term “strengthening agent” is used herein to describe a material whose inclusion in the biodegradable polymeric composition of the present invention results in an improvement in any of the characteristics “stress at maximum load”, “fracture stress”, “fracture strain”, “modulus”, and “toughness” measured for a solid article formed by curing of the composition, compared with the corresponding characteristic measured for a cured solid article obtained from a similar composition lacking the strengthening agent.

The term “curing” is used herein to describe subjecting the composition of the present invention to conditions of temperature and pressure effective to form a solid article.

The term “array” is used herein to mean a network structure.

The term “mat” is used herein to mean a collection of raw fibers joined together.

The term “prepreg” is used herein to mean a fiber structure that has been impregnated with a resin prior to curing the composition.

### Resin

As described above, a provided dry resin has many beneficial properties. Specifically, a provided dry resin can be transported or shipped for a fraction of the cost of shipping an aqueous resin due to significant decreases in weight and volume. A provided dry resin is resistant to microbiological growth without requiring further addition of preservatives. Further, a provided dry resin does not need to be frozen to resist microbial growth. In some aspects, the present invention provides a dry resin comprising a biodegradable polymeric composition. In some embodiments, a provided dry resin comprises a protein and a first strengthening agent. Such resin is made entirely of biodegradable materials. In some embodiments, a provided dry resin is made from a renewable source including a yearly renewable source. In some embodiments, no ingredient of the provided resin is toxic to the human body (i.e., general irritants, toxins or carcinogens). In certain embodiments, a provided resin does not include formaldehyde or urea derived materials.

### Suitable Protein

As generally described above, a provided biodegradable polymeric composition comprises a protein.

Suitable protein for use in a provided composition typically contains about 20 different amino acids, including those that contain reactive groups such as —COOH, —NH₂ and —OH groups. Once processed, protein itself can form crosslinks through the —SH groups present in the amino acid cysteine as well as through the dehydroalanine (DHA) residues formed from alanine by the loss of the α-hydrogen and one of the hydrogens on the methyl group side chain, forming an α,β-unsaturated amino acid. DHA is capable of reacting with lysine and cysteine by forming lysinoalanine and lanthionine crosslinks, respectively. Asparagines and lysine can also react together to form amide type linkages. All these reactions can occur at higher temperatures and under pressure that is employed during curing of the protein. However, the crosslinked protein is very brittle and has low strength.

Without wishing to be bound by a particular theory, it is believed that the protein concentration of a given protein source is directly proportional to the extent of crosslinking (the greater the protein concentration the greater crosslinking of the resin). Greater crosslinking in the resin produces composites with more rigidity and strength. Altering the ratio of protein to plasticizer allows those skilled in the art to select and fine tune the rigidity of the resulting composites.

In addition to the self-crosslinking capability of protein, the reactive groups can be utilized to modify the proteins further to obtain desired mechanical and physical properties. The most common protein modifications include: addition of crosslinking agents and internal plasticizers, blending with other resins, and forming interpenetrating networks (IPN) with other crosslinked systems. These modifications are intended to improve the mechanical and physical properties of the resin. The properties of the resins can be further improved by adding nanoclay particles and micro- and nano-fibrillated cellulose (MFC, NFC), as described in, for example, Huang, X. and Netravali, A. N., “Characterization of flax yarn and flax fabric reinforced nano-clay modified soy protein resin composites,” Compos. Sci. and Technol. 2007, 67, 2005; and Netravali, A. N.; Huang, X.; and Mizuta, K., “Advanced Green Composites,” Advanced Composite Materials 2007, 16, 269.

In some embodiments, a protein is a plant-based protein. In some embodiments, a provided plant-based protein is obtained from a seed, stalk, fruit, root, husk, stover, leaf, stem, bulb, flower or algae, either naturally occurring or bioengineered. In some embodiments, the plant-based protein is soy protein.

Soy Protein. Soy protein has been modified in various ways and used as resin in the past, as described in, for example, Netravali, A. N. and Chabba, S., Materials Today, pp. 22-29, April 2003; Lodha, P. and Netravali, A. N., Indus. Crops and Prod. 2005, 21, 49; Chabba, S. and Netravali, A. N., J. Mater. Sci. 2005, 40, 6263; Chabba, S. and Netravali, A. N., J. Mater. Sci. 2005, 40, 6275; and Huang, X. and Netravali, A. N., Biomacromolecules, 2006, 7, 2783.

Soy protein useful in the present invention includes soy protein from commercially available soy protein sources. The protein content of the soy protein source is proportional to the resulting strength and rigidity of the composite boards because there is a concomitant increase in the crosslinking of the resin. Soy protein sources generally contain about 5-20% carbohydrate, which can interfere with processing of the resin. Accordingly, in some embodiments the soy protein source is treated to remove any carbohydrates, thereby increasing the protein levels of the soy source. Although it is sometimes beneficial to remove excess carbohydrates from the soy protein source, doing so increases the cost and time necessary to process the resin. Accordingly, in other embodiments the soy protein source is not treated.

In some embodiments, the concentration of the soy protein in the soy protein source is about 90-95%. In other embodiments, the concentration of the soy protein in the soy protein source is about 70-89%. In still other embodiments, the concentration of the soy protein in the soy protein source is about 60-69%. In still other embodiments, the concentration of the soy protein in the soy protein source is about 45-59%.

In some embodiments, the soy protein source is soy protein isolate.

In some embodiments, the soy protein source is soy protein concentrate. In some embodiments, the soy protein concentrate is commercially available, for example, Arcon S® or Arcon F®, which may be obtained from Archer Daniels Midland.

In some embodiments, the soy protein source is soy flour. In certain embodiments, the soy flour is ADM 7B and Cargill 100-90.

Alternative Proteins. As described above, suitable protein for use in the present invention includes plant-based protein. In certain embodiments, the plant-based protein is other than a soy-based protein. In some embodiments, a provided plant-based protein is obtained from a seed, stalk, fruit, root, husk, stover, leaf, stem, algae, bulb or flower, either naturally occurring or bioengineered. In some embodiments, the plant-based protein obtained from seed is a canola or sunflower protein. In other embodiments, the plant-based protein obtained from grain is rye, wheat or corn protein. In still other embodiments, a plant-based protein is isolated from protein-producing algae.

In other embodiments, a protein suitable for use in the present invention includes animal-based protein, such as collagen, gelatin, casein, albumin, silk and elastin.

In some embodiments, a protein for use in the present invention includes protein produced by microorganisms. In some embodiments, such microorganisms include algae, bacteria and fungi, such as yeast.

In still other embodiments, a protein for use in the present invention includes biodiesel byproducts.

### Strengthening Agent

As described generally above, a provided dry resin includes a first strengthening agent. In one embodiment, the strengthening agent is a green polysaccharide. In another embodiment, the strengthening agent is a carboxylic acid. In yet another embodiment, the strengthening agent is a nanoclay. In yet another embodiment, the strengthening agent is a microfibrillated cellulose or nanofibrillated cellulose. In some embodiments, the weight ratio of protein to first strengthening agent in the biodegradable polymeric composition of the present invention is about 20:1 to about 1:1. In some embodiments, the weight ratio of soy protein to first strengthening agent in the biodegradable polymeric composition of the present invention is about 50:1 to about 1:1.

Green Polysaccharides. In one embodiment, the first strengthening agent is a green polysaccharide. In one embodiment, the strengthening agent is soluble (i.e., substantially soluble in water at a pH of about 7.0 or higher). In some embodiments, the green polysaccharide is a carboxy-containing polysaccharide. In another embodiment, the green polysaccharide is agar, gellan, agaropectin or a mixture thereof.

Gellan gum is commercially available as Phytagel™ from Sigma-Aldrich Biotechnology. It is produced by bacterial fermentation and is composed of glucuronic acid, rhanmose and glucose, and is commonly used as a gelling agent for electrophoresis. Based on its chemistry, cured Phytagel™ is fully degradable. Gellan, a linear tetrasaccharide that contains glucuronic acid, glucose and rhamnose units, is known to form gels through ionic crosslinks at its glucuronic acid sites using divalent cations naturally present in most plant tissue and culture media. In the absence of divalent cations, higher concentration of gellan is also known to form strong gels via hydrogen bonding.

The mixing of gellan with soy protein isolate has been shown to result in improved mechanical properties. See, for example, Huang, X. and Netravali, A. N., Biomacromolecules, 2006, 7, 2783 and Lodha, P. and Netravali, A. N., Polymer Composites, 2005, 26, 647. During curing, crosslinking occurs in both the protein and in the polysaccharide, individually to form arrays of cured protein and arrays of polysaccharide. Intermingling occurs because the two arrays are mixed together. Hydrogen bonding occurs between the formed arrays of cured protein and cured polysaccharide because both arrays contain polar groups such as —COOH and —OH groups, and in the case of protein, —NH₂ groups.

In other embodiments, the green polysaccharide is selected from the group comprising carageenan, agar, gellan, agarose, alginic acid, ammonium alginate, annacardium occidentale gum, calcium alginate, carboxyl methyl-cellulose (CMC), carubin, chitosan acetate, chitosan lactate, E407a processed eucheuma seaweed, gelrite, guar gum, guaran, hydroxypropyl methylcellulose (HPMC), isabgol, locust bean gum, pectin, pluronic polyol F127, polyoses, potassium alginate, pullulan, sodium alginate, sodium carmellose, tragacanth, xanthan gum, galactans, agaropectin and mixtures thereof. In some embodiments, the polysaccharide may be extracted from seaweed and other aquatic plants. In some embodiments, the polysaccharide is agar agar.

Carboxylic acids and esters. In some embodiments, the first strengthening agent is a carboxylic acid or ester. Strengthening agents containing carboxylic acids or esters can crosslink with suitable groups on a protein. In some embodiments, the carboxylic acid or ester strengthening agent is selected from the group comprising caproic acids, caproic esters, castor bean oil, fish oil, lactic acids, lactic esters, poly L-lactic acid (PLLA) and polyols.

Other Polymers. In still other embodiments, the first strengthening agent is a polymer. In some embodiments, the polymer is a biopolymer. In one embodiment, the first strengthening agent is a polymer such as lignin. In other embodiments, the biopolymer is gelatin or another suitable protein gel.

Nanoclay. In some embodiments, the first strengthening agent is a clay. In other embodiments, the clay is a nanoclay. In some embodiments, a nanoclay has a dry particle size of 90% less than 15 microns. The composition can be characterized as green since the nanoclay particles are natural and simply become soil particles if disposed of or composted. The nanoclay does not take part in the crosslinking but is rather present as a reinforcing additive and filler. As used herein, the term “nanoclay” means clay having nanometer thickness silicate platelets. In some embodiments, a nanoclay is a natural clay such as montmorillonite. In other embodiments, a nanoclay is selected from the group comprising fluorohectorite, laponite, bentonite, beidellite, hectorite, saponite, nontronite, sauconite, vermiculite, ledikite, nagadiite, kenyaite and stevensite.

Cellulose. In some embodiments, the first strengthening agent is a cellulose. In some embodiments, a cellulose is a microfibrillated cellulose (MFC) or nanofibrillated cellulose (NFC). MFC is manufactured by separating (shearing) the cellulose fibrils from several different plant varieties. Further purification and shearing, produces nanofibrillated cellulose. The only difference between MFC and NFC is size (micrometer versus nanometer). The compositions are green because the MFC and NFC degrade in compost medium and in moist environments through microbial activity. Up to 60% MFC or NFC by weight ((uncured protein plus green strengthening agent basis) improves the mechanical properties of the composition significantly. The MFC and NFC do not take part in any crosslinking but rather are present as strengthening additives or filler. However they are essentially uniformly dispersed in the biodegradable composition and, because of their size and aspect ratio, act as reinforcement.

Other Strengthening Agents. It will be appreciated by those skilled in the art that any cross-linking agent may be used as a strengthening agent in the present invention. For example, in some embodiments, a strengthening agent is a cross-linking agent such as azetidinium resins, polyamide-epichlorohydrin resins, epoxide resins, polyacrylamide-glyoxal resins, carbodiimides, hydroxysuccinamide esters or hydrazide. In other embodiments, a strengthening agent is an aldehyde, such as formaldehyde or acetaldehyde, or dialdehyde, such as glutaraldehyde or glyoxal. In still other embodiments, a strengthening agent is a polyphosphate such as sodium pyrophosphate.

It will be appreciated by those skilled in the art that the resin of the present invention also includes resins containing various combinations of strengthening agents. For example only, in one embodiment the resin composition comprises a protein from 98% to 20% by weight protein (uncured protein plus first strengthening agent basis) and from 2% to 80% by weight of first strengthening agent (uncured protein plus first strengthening agent basis) wherein the first strengthening agent consists of from 1% to 65% by weight cured green polysaccharide and from 0.1% to 15% by weight nanoclay (uncured protein plus nanoclay plus polysaccharide basis).

In another embodiment, the resin composition comprises a protein from 98% to 20% by weight protein (uncured protein plus first strengthening agent basis) and from 2% to 80% by weight of first strengthening agent (uncured protein plus first strengthening agent basis) wherein the first strengthening agent consists of from 1% to 79% by weight cured green polysaccharide and from 0.1% to 79% by weight microfibrillated or nanofibrillated cellulose (uncured protein plus polysaccharide plus MFC or NFC basis).

### Plasticizer

As described above, the dry resin containing a protein and a first strengthening agent optionally further comprises a plasticizer. Without wishing to be bound by any particular theory, it is believed that the addition of a plasticizer reduces the brittleness of the crosslinked protein, thereby increasing the strength and rigidity of the composite. In some embodiments, the weight ratio of plasticizer: (protein+first strengthening agent) is about 1:20 to about 1:4. In some embodiments, the ratio of protein to plasticizer is 4:1. Suitable plasticizers for use in the present invention include a hydrophilic or hydrophobic polyol. In some embodiments, a provided polyol is a C₁₋₃ polyol. In one embodiment, the C₁₋₃ polyol is glycerol. In other embodiments, a provided polyol is a C₄₋₇ polyol. In one embodiment, the C₄₋₇ polyol is sorbitol. In some embodiments, the C₄₋₇ polyol is selected from propylene glycol, diethylene glycol and polyethylene glycols in the molecular weight range of 200-400 atomic mass units.

In certain embodiments, a polyol plasticizer is a polyphosphate such as sodium pyrophosphate.

In still other embodiments, a plasticizer is selected from the group comprising environmentally safe phthalates diisononyl phthalate (DINP) and diisodecyl phthalate (DIDP), food additives such as acetylated monoglycerides alkyl citrates, triethyl citrate (TEC), acetyl triethyl citrate (ATEC), tributyl citrate (TBC), acetyl tributyl citrate (ATBC), trioctyl citrate (TOC), acetyl trioctyl citrate (ATOC), trihexyl citrate (THC), acetyl trihexyl citrate (ATHC), butyryl trihexyl citrate (BTHC), trimethyl citrate (TMC), alkyl sulfonic acid phenyl ester (ASE), lignosulfonates, beeswax, oils, sugars, polyols such as sorbitol and glycerol, low molecular weight polysaccharides or a combination thereof.

### Antimoisture Agent

A provided resin optionally further comprises an antimoisture agent which inhibits moisture absorption by the composite. The antimoisture agent may also optionally decrease any odors that result from the use of proteins. In some embodiments, an antimoisture agent is a wax or an oil. In other embodiments, an antimoisture agent is a plant-based wax or plant-based oil. In still other embodiments, an antimoisture agent is a petroleum-based wax or petroleum-based oil. In yet other embodiments, an antimoisture agent is an animal-based wax or animal-based oil.

In some embodiments, a plant-based antimoisture agent is selected from the group comprising carnauba wax, tea tree oil, soy wax, soy oil, lanolin, palm oil, palm wax, peanut oil, sunflower oil, rapeseed oil, canola oil, algae oil, coconut oil and carnauba oil.

In some embodiments, a petroleum-based antimoisture agent is selected from the group comprising paraffin wax, paraffin oil and mineral oil.

In some embodiments, an animal-based antimoisture agent is selected from the group comprising beeswax and whale oil.

In some embodiments, an antimoisture agent is a lignin. In some embodiments, an antimoisture agent is a lignosulfonate. In still other embodiments, an antimoisture agent is stearic acid. In other embodiments, an antimoisture agent is a salt of stearic acid, such as sodium stearate, calcium stearate. In some embodiments, an antimoisture agent is a stearate ester such as polyethylene glycol stearate, methyl-, ethyl-, propyl, butyl-stearate, and the like, octyl-stearate, isopropyl stearate, myristyl stearate, ethylhexyl stearate, cetyl stearate and isocetyl stearate.

In some embodiments, an antimoisture agent is a cross-linking agent such as azetidinium resins, polyamide-epichlorohydrin resins, epoxide resins, polyacrylamide-glyoxal resins, carbodiimides, hydroxysuccinamide esters or hydrazide. In other embodiments, an antimoisture agent is an aldehyde or dialdehyde, such as glutaraldehyde or glyoxal. In still other embodiments, an antimoisture agent is a polyphosphate such as sodium pyrophosphate. In some embodiments, an antimoisture agent is a polyethylene or polypropylene emulsion. In certain embodiments, an antimoisture agent is an ethylene-acrylic acid copolymer.

It will be appreciated by those skilled in the art that, in some embodiments, one additive in the present invention may serve a dual purpose. For example, as described above, in some embodiments, a cross-linking agent such as a carbodiimide, hydroxysuccinamide ester or hydrazide is both a first strengthening agent and an antimoisture agent. In other embodiments, a polyol such as polyproplyene glycol, diethylene glycol or polyphosphate is both a plasticizer and an antimoisture agent. Those skilled in the art can readily identify which agents serve more than one purpose.

### Antimicrobial Agent

In accordance with the present invention, the protein resin may optionally contain an antimicrobial agent. In some embodiments, an antimicrobial agent is an environmentally safe agent. In some embodiments, an antimicrobial agent is a guanidine polymer. In some embodiments, the guanidine polymer is Teflex®. In other embodiments, an antimicrobial agent is selected from the group comprising essential oils such as tea tree oil, sideritis, oregano oil, mint oil, sandalwood oil, clove oil, nigella sativa oil, onion oil, leleshwa oil, lavendar oil, lemon oil, eucalyptus oil, peppermint oil, cinnamon oil, thyme oil. In some embodiments, an antimicrobial agent is selected from parabens, paraben salts, quaternary ammonium salts such as n-alkyl dimethylbenzyl ammonium chloride or didecyldimethyl ammonium chloride, allylamines, echinocandins, polyene antimycotics, azoles, isothiazolinones, imidazolium, sodium silicates, sodium carbonate, sodium bicarbonate, sulfite salts such as sodium or potassium sulfite, bisulfite salts such as sodium or potassium bisulfite, metabisulfite salts such as sodium or potassium metabisulfite, benzoic acid, benzoate salts such as sodium or potassium benzoate, potassium iodide, silver, copper, sulfur, grapefruit seed extract, lemon myrtle, olive leaf extract, patchouli, citronella oil, orange oil, pau d'arco and neem oil. In some embodiments, the parabens are selected from the group comprising methyl, ethyl, butyl, isobutyl, isopropyl and benzyl paraben and salts thereof. In some embodiments, the azoles are selected from the group comprising imidazoles, triazoles, thiazoles and benzimidazoles.

In some embodiments, an antimicrobial agent is boric acid or an acceptable salt thereof. In some embodiments, an antimicrobial agent is a boric acid salt, such as sodium borate, sodium tetraborate, disodium tetraborate, potassium borate, potassium tetraborate, and the like.

In some embodiments, an antimicrobial agent is Microban™.

In some embodiments, an antimicrobial agent is pyrithione salts such as zinc pyrithione, sodium pyrithione, etc.

### Composites

In some embodiments, a provided dry resin is useful for combination with green reinforcing materials to form a composite.

### Fiber

In some embodiments, the present invention provides a composite comprising a biodegradable polymeric composition, as described herein. In certain embodiments, a provided composite is comprised of a protein, a first strengthening agent and an optional second strengthening agent of natural origin that can be a particulate material, a fiber, or a combination thereof. More precisely, the second strengthening agent of natural origin includes green reinforcing fiber, filament, yarn, and parallel arrays thereof, woven fabric, knitted fabric and/or non-woven fabric of green polymer different from the protein, or a combination thereof.

In some embodiments, a second strengthening agent is a woven or non-woven, scoured or unscoured natural fiber. In some embodiments, a natural scoured, non-woven fiber is cellulose-based fiber. In other embodiments, a natural scoured, non-woven fiber is animal-based fiber.

In some embodiments, a cellulose-based fiber is fiber obtained from a commercial supplier and available in a variety of packages, for example loose, baled, bagged, or boxed fiber. In other embodiments, the cellulose-based fiber, is selected from the group comprising kenaf, hemp, flax, wool, silk, cotton, ramie, sorghum, raffia, sisal, jute, sugar cane bagasse, coconut, pineapple, abaca (banana), sunflower stalk, sunflower hull, peanut hull, wheat straw, oat straw, hula grass, henequin, corn stover, bamboo and saw dust. In other embodiments, a cellulose-based fiber is a recycled fiber from clothing, wood and paper products. In still other embodiments, the cellulose-based fiber is manure. In yet other embodiments, the cellulose-based fiber is regenerated cellulose fiber such as viscose rayon and lyocell.

In some embodiments, an animal-based fiber includes hair or fur, silk, fiber from feathers from a variety of fowl including chicken and turkey, and regenerated varieties such as spider silk and wool.

In some embodiments, a non-woven fiber may be formed into a non-woven mat.

In some embodiments, a non-woven fiber is obtained from the supplier already scoured. In other embodiments, a non-woven fiber is scoured to remove the natural lignins and pectins which coat the fiber. In still other embodiments, a non-woven fiber is used without scouring.

In yet other embodiments, a fiber for use in the present invention is scoured or unscoured, woven fabric. In some embodiments, a woven fabric is selected from the group comprising burlap, linen or flax, wool, cotton, hemp, silk and rayon. In some embodiments, the woven fabric is burlap. In another embodiment, the woven fabric is a dyed burlap fabric. In still another embodiment, the woven fabric is an unscoured burlap fabric.

In still other embodiments, a fiber for use in the present invention is a combination of non-woven fiber and woven fabric.

In some embodiments, the woven fabric is combined with a provided resin comprising a protein and a first strengthening agent and pressed into a composite as described herein, infra.

In certain embodiments, the composite is comprised of a provided dry resin comprising a protein, a first strengthening agent and optionally a second strengthening agent, wherein the second strengthening agent is combined with a provided dry resin to form a resin/mat complex, which may be optionally moistened with water. Two or more resin/mat complexes may be optionally stacked to achieve a desired thickness.

In some embodiments, the second strengthening agent is pretensioned prior to being impregnated and/or cured.

Optionally, the resin/mat complexes are stacked or interlayered with one or more optionally impregnated woven fabrics, resulting in a stronger and more durable composite. In some embodiments, the resin/mat complexes are interlayered with optionally impregnated woven burlap. In some embodiments, the outer surfaces of the stack of resin/mat complexes are covered with decorative or aesthetic layers such as fabrics or veneers. In some embodiments, the fabrics are silkscreened to produce a customized composite. Significantly, the present invention further provides for a one-step process for pressing and veneering a composite without the use of a formaldehyde-based adhesive, as the resin itself crosslinks the prepregs with the veneer, resulting in a biodegradable veneered composite. In other embodiments, the veneer is adhered to the composite with a suitable adhesive, for example wood glue.

In some embodiments, the stacked resin/mat complexes can be pressed directly into a mold, thereby resulting in a contoured composite. In a further embodiment, the resin/mat complex can be both veneered and molded in a single step. Wood for a veneer ply includes but is not limited to any hardwood, softwood or bamboo. In some embodiments, the veneer is bamboo, pine, white maple, red maple, poplar, walnut, oak, redwood, birch, mahogany, ebony and cherry wood.

In some embodiments, the composites can contain variable densities throughout a single board. In some embodiments, composites of the present invention contain at least one contoured surface. In some embodiments, composites of the present invention contain two contoured surfaces. In some embodiments, the variable density is created by a mold which is contoured on one surface but flat on the other, thereby applying variable pressure to the contoured surface. In other embodiments, the variable density is created by building up uneven layers of prepregs, where the more heavily layered areas result in the more dense sections of the composite boards.

In some embodiments, the pressing of the resin/mat complexes contains a tooling step, which may occur before or after the pressing or curing step but prior to or after the release of the composite from the mold. In some embodiments, the tooling step occurs after the resin/mat complexes are loaded into the mold but prior to the pressing or curing step. Such step comprises subjecting the mold containing the resin/mat complexes to a tooling apparatus which trims the outer edges of the resin/mat complex which, when pressed or cured, produce a composite without the need for further shaping or refining. In some embodiments, the resin/mat complex material trimmed from the outside of the mold can be recycled by grinding up and adding the trimmings back into the resin.

In other embodiments, the tooling step occurs after the pressing or curing of the composite but before the composite is released from the mold.

### Applications for Biodegradable Composites

As will be appreciated by those skilled in the art, composites comprising biodegradable compositions are useful in the manufacture of consumer products. Consumer products composed of composites comprising biodegradable compositions are fire-retardant as compared to conventional materials such as wood and particle board. Of particular note, consumer products comprised of composites comprising biodegradable compositions, such as furniture, sports equipment and home decor, are renewable and compostable at the end of their useful life, thereby reducing landfill waste. Further, in some embodiments, such composites comprising biodegradable compositions are produced without the use of formaldehyde or other toxic chemicals such as isocyanates or embodied in epoxys.

In certain embodiments, composites comprising biodegradable compositions are incorporated into furniture. In some embodiments, the furniture may include tables, desks, chairs, shelving, buffets, wet bars, benches, chests, vanities, stools, dressers, bed frames, futon frames, baby cribs, entertainment stands, bookcases, etc. In some embodiments, the furniture may include couches and recliners containing frames comprised of composites comprising biodegradable composition. In some embodiments, the furniture may be office furniture, such as cubicle walls. In some embodiments, the cubicle walls have variable densities to accommodate push pins. The cubicle walls may also contain a plurality of channels within which wires and cables may be concealed. In other embodiments, the office furniture may be desks, chairs or shelving. In some embodiments, provided composites are customized with inlays, logos, colors, designs, etc.

In some embodiments, provided composites comprising biodegradable compositions are used to create home decor products. Such home decor products include picture frames, wall coverings, cabinets and cabinet doors, decorative tables, serving trays and platters, trivets, placemats, decorative screens, decorative boxes, corkboards, etc. In some embodiments, the composites are customized with inlays, logos, colors, designs, etc.

In some embodiments, provided composites comprising biodegradable compositions are useful in the manufacturing of tools and industrial equipment, including ladders, tool handles such as hammer, knife or broom handles, saw horses, etc.

In some embodiments, provided composites comprising biodegradable compositions are useful in the manufacturing of musical instruments, including guitars, pianos, harpsichords, violins, cellos, bass, harps, violas, banjos, lutes, mandolins and musical bows.

In some embodiments, provided composites comprising biodegradable compositions are useful in the manufacturing of caskets or coffins. Of particular note, it will be appreciated that a provided casket will be engineered to biodegrade at the same or slightly slower rate than its contents. In some embodiments, provided caskets are veneered during the molding/pressing process.

In some embodiments, composites comprising biodegradable compositions are useful in the manufacturing of sports equipment. Such sports equipment includes skateboards, snowboards, snow skis, tennis racquets, golf clubs, bicycles, scooters, shoulder, elbow and knee pads, basketball backboards, lacrosse sticks, hockey sticks, skim boards, wakeboards, water-skis, boogie boards, surf boards, wake skates, snow skates, snow shoes, etc. In some embodiments, the composites are customized with inlays, logos, colors, designs, etc.

In some embodiments, composites comprising biodegradable compositions are useful in the manufacturing of personal products, such as hats, pins, buttons, bracelets, necklaces, etc.

In some embodiments, composites comprising biodegradable compositions are useful in the manufacturing of electronic items, such as circuit boards.

In other embodiments, composites comprising biodegradable compositions are useful in the manufacturing of product casing, packaging and mass-volume disposable consumer goods.

In some embodiments, composites comprising biodegradable compositions are useful in the manufacturing of building materials.

In other embodiments, composites comprising biodegradable compositions are useful in the manufacturing of automobile, airplane, train, bicycle or space vehicle parts.

### General Process for Preparing Provided Composites

In preparing a resin of the present invention, the first strengthening agent is dissolved in water to form a solution or weak gel, depending on the concentration of the first strengthening agent. The resulting solution or gel is added to the initial protein suspension, with or without a plasticizer, under conditions effective to cause dissolution of all ingredients to produce a resin comprising a biodegradable polymeric composition. In accordance with the present invention, the resin is then dried to a powder. In some embodiments, the resin is spray dried. In other embodiments, the resin is freeze-dried. In still other embodiments, the resin is dried in ambient air. In yet other embodiments, the resin is drum dried.

In other embodiments, the present invention provides a more concentrated resin which decreases the amount of energy required to both prepare and dry the aqueous resin to powder form. In some embodiments, the more concentrated resin is spray dried. In other embodiments, the resin is freeze-dried. In still other embodiments, the resin is dried in ambient air. In yet another embodiment, the resin is drum dried.

In certain embodiments, an aqueous resin mixture of the present invention is more concentrated than the previously disclosed resin to minimize the amount of water to be removed. In some embodiments, the dry resin ingredients are combined with little to no water and used as such. The more concentrated resin can be used to impregnate fiber mats, which are then optionally dried to produce prepregs as previously described. The prepregs are then subjected to conditions of temperature and/or pressure sufficient to form a composite.

A provided dry resin comprising a protein and a first strengthening agent, and further optionally comprising an antimoisture agent, an antimicrobial agent, and an additional strengthening agent is then optionally combined with a second strengthening agent, consisting of woven or non-woven fibers.

The impregnation of the second strengthening agent is accomplished by a variety of methods known to a person of ordinary skill in the art, as described generally below.

For example only, the dry resin may be integrated with the second strengthening agent fibers by a powder impregnation process as described in Rath et al., “Manufacture of aramid fibre reinforced nylon-12 by dry powder impregnation process,” Composites Part A: Applied Science and Manufacturing 29(8):933-938 (1998); Cooper et al., “Distribution and alignment of carbon nanotubes and nanofibrils in a polymer matrix,” Composites Science and Technology 62:1105-1112 (2002); Iyer et al., “Manufacture of Powder-Impregnated Thermoplastic Composites,” Journal of Thermoplastic Composite Materials 3(4):325-355 (October 1990); Zhang et al., “Investigation on the uniformity of high-density polyethylene/wood fiber composites in a twin-screw extruder,” Journal of Applied Polymer Science 113(4):2081-2089 (April 2009); Soleimani et al., “The Effect of Fiber Pretreatment and Compatibilizer on Mechanical and Physical Properties of Flax Fiber-Polypropylene Composites,” Journal of Polymers and the Environment 16(11):74-82 (January 2008); Ye et al, “Impregnation and Consolidation in Composites Made of GF/PP Powder Impregnated Bundles,” Journal of Thermoplastic Composite Materials 5:32-48 (1992).

Alternatively, the resin is treated with alkali and maleated polyolefins, thereby improving fiber-matrix adhesion, as described in Mohanty et al., “Engineered natural fiber reinforced polypropylene composites: influence of surface modifications and novel powder impregnation processing,” J. Adhes. Sci. Technol. 16(8):999-1015 (2002). A radio frequency plasma technique has been used to deposit a range of conformal, pinhole-free, highly adhering copolymer coatings with functionality. Therefore, the fibers may be impregnated using plasma co-polymerization, as described in Lopattananon, et al., “Interface molecular engineering of carbon-fiber composites,” Composites Part A: Applied Science and Manufacturing 30(1): 49-57 (January 1999).

A provided dry resin powder may be alternatively mixed with dried wood flakes using an intensive impeller blender as described in Balasuriya et al., “Mechanical properties of wood flake—polyethylene composites. Part I: effects of processing Methods and matrix melt flow behaviour,” Composites Part A: Applied Science and Manufacturing 32(5):619-629 (May 2001).

The dry resin surface may be modified with coupling agents such as (3-aminopropyl)-triethoxysilane (AS), 3-(trimethoxysilyl)-1-propanethiol (MS), and maleic anhydride grafted polypropylene (MAPP), as described in Demir et al., “The effect of fiber surface treatments on the tensile and water sorption properties of polypropylene—luffa fiber composites,” Composites Part A: Applied Science and Manufacturing 37(3):447-456 (March 2006).

A provided resin powder may be mechanically mixed with fiber and a coupling agent, as described in Zampaloni et al., “Kenaf natural fiber reinforced polypropylene composites: A discussion on manufacturing problems and solutions,” Composites Part A: Applied Science and Manufacturing 38(6):1569-1580 (June 2007).

Alkali treatment of resins is a key technology for improving mechanical properties of cellulose-based fiber composites. As such, a provided dry resin may be treated with a highly concentrated alkali solution, as described in Gomes et al., “Development and effect of alkali treatment on tensile properties of curaua fiber green composites,” Composites Part A: Applied Science and Manufacturing 38(8):1811-1820 (August 2007). Alternatively, paraffin may be used as a dispersing agent to reduce agglomeration of wood fibers in the polyolefin matrix, as described in Viksne et al., “The effect of paraffin on fiber dispersion and mechanical properties of polyolefin-sawdust composites,” Journal of Applied Polymer Science 93(5):2385-2393 (September 2004).

Fibers may be passed through a pneumatic spreader and heated in a convection oven before being subjected to a vibrating bath of polymer powder and coated, as described in Nunes et al., “New thermoplastic matrix composites for demanding applications,” Plastics, Rubber and Composites 38(2-4):167-172 (May 2009). The dry resin powder may be slurried in an aqueous foam which deposits the resin polymer on the fiber. Chary et al., “Coating carbon fibers with a thermoplastic polyimide using aqueous foam,” Polymer Composites 15(4):306-311 (August 1994); Tang et al., “Aqueous powder slurry manufacture of continuous fiber reinforced polyethylene composite,” Polymer Composites 18(2):223-231 (April 1997).

A fiber is alternatively impregnated with the resin powder which it then melt-impregnated in a small pultrusion die to form a well-defined rectangular cross section, as described in Åstrom et al., “Thermoplastic Filament Winding with On-Line Impregnation,” Journal of Thermoplastic Composite Materials 3:314-324 (1990). The dry resin powder may be slurried in an aqueous medium and used to impregnate fibers. Vodermayer et al., “Manufacture of high performance fibre-reinforced thermoplastics by aqueous powder impregnation,” Composites Manufacturing 4(3):123-132 (September 1993).

A provided resin powder may be melted on the fibers by radiant heating to permanently adhere the polymer to the fiber. Muzzy et al., “Electrostatic Prepregging of Thermoplastic Matrices,” SAMPE J. 25(5):15-21 (September-October 1989). In the manufacture of high performance composites, the hot melt prepregging process is used to initially wet reinforcing fibers with matrix resin in order to produce a uniform lamina structure. Hoisington et al., “Scale-up for hot melt prepreg manufacturing,” International SAMPE Symposium and Exhibition, 37th, Anaheim, Calif., Mar. 9-12, 1992, Proceedings (A93-15726 04-23), p. 264-277. The dry resin may be deposited on the fiber via a Fibroline Electrostatic method. See http://www.fibroline.com/impregnation-phenomenon.htm.

A fiber structure may be impregnated with the dry resin to form homogeneously impregnated fiber reinforced resin pellets, as described in U.S. Pat. No. 6,620,507.

A fiber may be impregnated by a vacuum assisted powder impregnation method which combines vacuum assisted resin transfer molding (VARTM) with compression molding. Steggall-Murphya et al., “A model for thermoplastic melt impregnation of fiber bundles during consolidation of powder-impregnated continuous fiber composites,” Composites Part A: Applied Science and Manufacturing 41(1):93-100 (January 2010).

A provided resin may be treated to form a stable emulsion of particles which penetrate the fiber strand, substantially filling the gaps between individual fibers, as described in U.S. Pat. No. 6,861,131.

A fiber may be impregnated by moving a tow of long continuous fibers through a processing space and discharging a pressurized fluid stream entrained with a number of resin particles into the processing space through an orifice. The stream diverges from the orifice to distribute the particles in the processing space. At least a portion of the particles received in the processing space are electrostatically charged with a wire electrode positioned in the processing space. Provided resin particles are deposited on the tow and fixed thereto. The electrode generates a cylindrically shaped corona charging region which may be oriented relative to the tow and orifice to control particle deposition. U.S. Pat. No. 5,895,622.

A provided dry resin may be pretreated by stearic acid before impregnation of fibers. Grande et al., “Investigation of fiber organization and damage during single screw extrusion of natural fiber reinforced thermoplastics,” Advances in Polymer Technology 24(2):145-156 (2005); Tones et al., “Study of the interfacial properties of natural fibre reinforced polyethylene,” Polymer Testing 24:694-698 (2005).

The process of impregnation optionally includes a wetting agent, which assures good contact between the dry resin system and the fiber surface. Wetting agents can decrease the duration of impregnation process and result in a more thoroughly impregnated fiber/resin complex. Suitable wetting agents for use in the present invention include propylene glycol, alkylphenol ethoxylates (APEs), Epolene E-43, lauric-acid containing oils such as coconut, Cuphea, Vernonia, and palm kernel oils, ionic and non-ionic surfactants such as sodium dodecylsulfate and polysorbate 80, soy-based emulsifiers such as epoxidized soybean oil and epoxidized fatty acids, soybean oil, linseed oil, castor oil, silane dispersing agents such as Z-6070, polylactic acids such as ethoxylated alcohols UNITHOX™ 480 and UNITHOX™ 750 and acid amide ethoxylates UNICID™, available from Petrolite Corporation, ethoxylated fluorol compounds such as zonyl FSM by Dupont, Inc., ethoxylated alkyl phenols and alkylaryl polyethers, C₁₂-C₂₅ carboxylic acids such as lauric acid, oleic acid, palmitic acid or stearic acid, sorbitan C₁₂-C₂₅ carboxylates such as sorbitan monolaurate, sorbitan monopalmitate, sorbitan monostearate, sorbitan tristearate, sorbitan monooleate or sorbitan trioleate, Gemini surfactants, zinc stearate, high-molecular weight wetting agents such as DISPERBYK-106, DISPERBYK-107 and DISPERBYK-108, available from BYK USA, hyper-branched polymers such as Starfactant™, available from Cognis Corporation, amino acid-glycerol ethers, surfactants such as Consamine CA, Consamine CW, Consamine DSNT, Consamine DVS, Consamine JDA, Consamine JNF, Consamine NF, Consamine PA, Consamine X, and Consowet DY, available from Consos, Inc., waxes such as Luwax PE and montan waxes, Busperse 47, available from Buckman Laboratories, non-ionic or anionic wetting agents such as TR041, TR251 and TR255, available from Struktol Company of America, Hydropalat® 120, Igepal CO 630, available from Stepan, Polytergent B-300, available from Harcros Chemical, Triton X-100, available from Union Carbide, alkylated silicone siloxane copolymers such as BYK A-525 and BYK W-980, available from Byk-Chemie, neoalkoxy zirconate and neoalkoxy titanate coupling agents such as Ken React LZ-37, Ken React LZ-97 and LICA 44, available from Kenrich Petrochemicals, Inc., copolyacrylates such as Perenol F-40, available from Henkel Corporation, bis(hexamethylene)triamine, Pave 192, available from Morton International, decyl alcohol ethoxylates such as DeTHOX DA-4 and DeTHOX DA-6, available from DeForest, Inc., sodium dioctyl sulfosuccinate, Igepal CO-430, available from GAF Corp., and dispersion aids such as Z-6173, available from Dow Corning Corp.

In some embodiments, suitable wetting agents include epoxidized oils or fatty acids which can react with the hydroxyl groups of the starch ester and the cellulose fibers, thereby further increasing the compatibility between the fiber and the matrix. Exemplary fatty acids and low molecular weight linear aliphatic polyesters include polycaprolactone, polyalkanoates and polylactic acid.

Following impregnation, the fiber/resin complex may be optionally cut to desired size and shape. A provided resin/fiber complex is then formed into a sheet that when cured, either by applying heat or heat and pressure, will form a layer. To obtain thicker composite sheets, a plurality of sheets can be stacked for curing. The sheets can be stacked with unidirectional fibers and yarns at different angles in different layers.

In some embodiments, a provided dry resin is reconstituted with water prior to impregnating a fiber or fabric. In other embodiments, a provided dry resin is applied directly to a dry fiber or fabric. In still other embodiments, a provided dry resin is applied to dry fiber or fabric and a minimal amount of water is added to facilitate the curing step.

### EXEMPLIFICATION

A provided dry resin comprising a biodegradable polymeric composition in accordance with the present invention may be prepared by the following illustrative procedures.

### Example 1

The agar mixture was prepared in a separate container by mixing an appropriate amount of agar with an appropriate amount of water at or below room temperature.

A 50 L mixing kettle was charged with 25 L water and heated to about 50° C. to about 85° C. Half of the appropriate amount of protein was added and the pH of the mixture of adjusted to about 7-14 with a suitable base, for example a 1N sodium hydroxide solution. To the resulting mixture were added Teflex® and sorbitol, followed by the preformed agar mixture. The remainder of the protein was then added and a sufficient volume of water added to the mixture to bring the total volume to about 55 L. The mixture was allowed to stir at about 70° C. to about 90° C. for 30-60 minutes. The beeswax was then added and the resin mixture was allowed to stir at about 70° C. to about 90° C. for about 10-30 minutes.

The prepared resin was then dried by spray drying or, alternatively, drum drying.

The dry resin was reconstituted using nine parts of water and one part dry resin. The mixture was heated to 90° C. and stirred until mostly dissolved.

The reconstituted resin so produced was used to impreg six layers of non-woven fiber. Enough reconstituted resin was added to bring the ratio of resin solids to dry fiber to 50:50. The non-woven fiber mats were impregnated with the resin for about 5 minutes, before being loosely rolled and allowed to stand for about 0-5 hours. The resin-impregnated mat was then optionally resubjected to the resin by additional passes through the impregger, before being loosely rolled and optionally allowed to stand for about 0-5 hours. In some embodiments, the prepreg is processed without a standing or resting step, for example in a high-throughput process utilizing continuously moving machinery such as a conveyor belt. The prepregs were dried overnight to a moisture content of 6-9%. The stack of six preregs was pressed for 13 minutes under the normal conditions of 50 tons per square foot and 125° C.

### Example 2

The agar mixture was prepared in a separate container by mixing an appropriate amount of agar with an appropriate amount of water at or below room temperature.

A 50 L mixing kettle was charged with 25 L water and heated to about 50° C. to about 85° C. Half of the appropriate amount of protein was added and the pH of the mixture of adjusted to about 7-14 with a suitable base, for example a 1N sodium hydroxide solution. To the resulting mixture were added Teflex® and sorbitol, followed by the preformed agar mixture. The remainder of the protein was then added and a sufficient volume of water added to the mixture to bring the total volume to about 55 L. The mixture was allowed to stir at about 70° C. to about 90° C. for 30-60 minutes. The beeswax was then added and the resin mixture was allowed to stir at about 70° C. to about 90° C. for about 10-30 minutes.

The prepared resin was then subject to drying by spray drying or, alternatively, drum drying. The dried resin was applied directly to damp fiber and then pressed. for 13 minutes under the normal conditions of 50 tons per square foot and 125° C.

### Example 3

A dry powder formulation was prepared consisting of soy-based flour or protein concentrate, agar, and sorbitol according to Example 2.

The dry powder was then sifted over the surface of 4-12 nonwoven fiber mats, mechanically scoured and rolled to work powder throughout the fiber mats.

An aqueous solution of suitable base, for example sodium hydroxide, was prepared, to which may be added soluble components, such as Teflex and/or Beeswax to increase moisture and/or microbial resistance.

The aqueous solution was then sprayed in an atomized mist over the powder-charged nonwoven fiber mats to achieve a suitable moisture content, for example, 6-9%. In some embodiments, the moisture content was raised above 6-9% and dried in a high-throughput process, such as on a conveyor, to obtain 6-9% moisture content.

In some embodiments, a dip-tank was charged with the aqueous solution described above and the nonwoven fiber mat is then passed through the solution and dried in a high-throughput process, such as on a conveyor, and then dried to 6-9% moisture.

The stack of charged and moisturized fiber mats were then pressed for 13 minutes under normal conditions of 50 tons per square foot and 125° C.

In some embodiments, the stacked moisturized mats are brought to a higher moisture content, for example 15-30% moist, and then pressed for 13 minutes at 125° C. with a fine screen to release excess moisture, effectively drying, curing, and shaping the composite in one step.

### Example 4

A dry powder formulation was prepared as stated in Example 3, and then applied to the nonwoven fiber mat as dry powder spray.

In some embodiments, the powder application can be further enhanced and overspray reduced by applying an electrostatic charge to the powder particles as it is being sprayed directly onto the nonwoven fiber mat.

The non-woven mat was then treated with the aqueous alkaline solution described in Example 3 by either passing the mat through the dip-tank containing the aqueous solution or spraying the mat with an atomized mist, both of which are also described in Example 3.

The stack of charged and moisturized fiber mats were then pressed as described in Example 3.

We claim:

1. A dry resin comprising a biodegradable polymeric composition comprising a protein and a first strengthening agent.

2. The dry resin of claim 1, wherein the composition comprises a protein selected from a plant-based protein, an animal-based protein and a biodiesel byproduct.

3. The dry resin of claim 2, wherein the composition comprises a plant-based protein selected from a soy-based protein from a soy protein source.

4. The dry resin of claim 3, wherein the composition comprises a soy protein source selected from soy flour, soy protein isolate and soy protein concentrate.

5. The dry resin of claim 2, wherein the composition comprises a plant-based protein obtained from a seed, stalk, fruit, root, husk, stover, leaf, stem, bulb, flower, or algae, either naturally occurring or bioengineered, and combinations thereof.

6. The dry resin of claim 5, wherein the composition comprises a plant-based protein selected from the group comprising soy, canola, sunflower, rye, wheat, corn, and combinations thereof.

7. The dry resin of claim 2, wherein the composition comprises an animal-based protein selected from the group comprising collagen, gelatin, casein, albumin, silk, elastin, and combinations thereof.

8. The dry resin of claim 1, wherein the composition comprises a first strengthening agent selected from a green polysaccharide, a carboxylic acid or ester, a nanoclay, a cellulose or a cross-linking agent.

9. The dry resin of claim 8, wherein the composition comprises a green polysaccharide selected from the group comprising gelatin, carageenan, other suitable protein gels, agar, gellan, agarose, alginic acid, ammonium alginate, annacardium occidentale gum, calcium alginate, carboxyl methyl-cellulose (CMC), carubin, chitosan acetate, chitosan lactate, E407a processed eucheuma seaweed, gelrite, guar gum, guaran, hydroxypropyl methylcellulose (HPMC), isabgol, locust bean gum, pectin, pluronic polyol F127, polyoses, potassium alginate, pullulan, sodium alginate, sodium carmellose, tragacanth, xanthan gum and combinations thereof.

10. The dry resin of claim 8, wherein the composition comprises a carboxylic acid or ester selected from the group comprising caproic acids, caproic esters, castor bean oil, fish oil, lactic acids, lactic esters, poly L-lactic acid (PLLA), polyols and combinations thereof.

11. The dry resin of claim 8, wherein the composition comprises a nanoclay selected from the group comprising montmorillonite, fluorohectorite, laponite, bentonite, beidellite, hectorite, saponite, nontronite, sauconite, vermiculite, ledikite, nagadiite, kenyaite, stevensite and combinations thereof.

12. The dry resin of claim 8, wherein the composition comprises a cellulose selected from a microfibrillated cellulose or a nanofibrillated cellulose.

13. The dry resin of claim 1, wherein the composition further comprises a plasticizer.

14. The dry resin of claim 13, wherein the composition comprises a polyol plasticizer.

15. The dry resin of claim 14, wherein the composition comprises a polyol plasticizer selected from glycerol, sorbitol, propylene glycol, diethylene glycol, polypropylene glycols in the molecular weight range of 200-400 amu or polyphosphates.

16. The dry resin of claim 13, wherein the composition comprises a plasticizer selected from the group comprising diisononyl phthalate (DINP), diisodecyl phthalate (DIDP), acetylated monoglycerides alkyl citrates, triethyl citrate (TEC), acetyl triethyl citrate (ATEC), tributyl citrate (TBC), acetyl tributyl citrate (ATBC), trioctyl citrate (TOC), acetyl trioctyl citrate (ATOC), trihexyl citrate (THC), acetyl trihexyl citrate (ATHC), butyryl trihexyl citrate (BTHC), trimethyl citrate (TMC), alkyl sulfonic acid phenyl ester (ASE), lignosulfonates, beeswax, oils, sugars, polyols, low molecular weight polysaccharides, and combinations thereof.

17. The dry resin of claim 1, wherein the composition further comprises an antimoisture agent.

18. The dry resin of claim 17, wherein the composition comprises an antimoisture agent selected from a petroleum-based wax, a petroleum-based oil, an animal-based wax, an animal-based oil, a plant-based wax or a plant-based oil.

19. The dry resin of claim 18, wherein the composition comprises an antimoisture agent selected from the group comprising paraffin wax, paraffin oil, mineral oil, beeswax, whale oil, carnauba wax, tea tree oil, soy wax, soy oil, lanolin, palm oil, palm wax, peanut oil, sunflower oil, rapeseed oil, canola oil, algae oil, coconut oil, carnauba oil, lignin, stearic acid, stearate salt, or stearate ester, carbodiimides, hydroxysuccinamide esters, hydrazides, aldehydes or dialdehydes, polyphosphates, polyethylene or polypropylene emulsions and ethylene-acrylic acid copolymers.

20. The dry resin of claim 1, wherein the composition further comprises an antimicrobial agent.

21. The dry resin of claim 30, wherein the composition comprises an antimicrobial agent selected from Teflex®, boric acid or a salt thereof, Microban™, pyrithione salts, parabens, paraben salts, quaternary ammonium salts, allylamines, echinocandins, polyene antimycotics, azoles, isothiazolinones, imidazolium, sodium silicates, sodium carbonate, sodium bicarbonate, potassium iodide, silver, copper, or sulfur, sulfite salts, bisulfite salts, metabisulfite salts, benzoic acid, benzoate salts, or an essential oil comprising tea tree oil, sideritis, oregano oil, mint oil, sandalwood oil, clove oil, nigella sativa oil, onion oil, leleshwa oil, lavendar oil, lemon oil, eucalyptus oil, peppermint oil, cinnamon oil, thyme oil, grapefruit seed extract, lemon myrtle, olive leaf extract, patchouli, citronella oil, orange oil, pau d'arco or neem oil, or a mixture thereof.

22. A method of preparing a dry resin comprising a biodegradable polymeric composition comprising the steps of:
i. preparing an aqueous resin comprising a protein and a first strengthening agent; and
ii. removing the water to produce a dry resin.

23. The method of claim 22, wherein the method further comprises the steps of:
i. reconstituting the resin in a minimum amount of water;
ii. impregnating a fiber or fabric with the reconstituted resin to form at least one prepreg;
iii. optionally stacking a plurality of prepregs; and
iv. pressing at least one prepreg under conditions sufficient to form the composite.

24. The method of claim 22, wherein the resin is spray dried.

25. The method of claim 22, wherein the resin is drum dried.

26. The method of claim 22, wherein the resin is air dried.

27. The method of claim 22, wherein the resin is freeze-dried.
